(19) United States
(12) Patent Application Publication
(10) Pub. No.: US 2010/0005916 A1
(43) Pub. Date: Jan. 14, 2010

(54) MOTORCYCLE FOOT CONTROLS

(76) Inventor: Richard Lee Briggs, JR., Saratoga Springs, NY (US)

Correspondence Address: DELAIN LAW OFFICE, PLLC, 107 NORTH COLLEGE ST., SCHENECTADY, NY, 12305, US

(21) Appl. No.: 12/170,404

(22) Filed: Jul. 9, 2008

(51) Int. Cl. B60K 20/04

(52) U.S. Cl. 74/473.16

(57) ABSTRACT

A motorcycle foot control mechanism is described and claimed, said motorcycle foot control mechanism comprising a left rockerboard bracket, said rockerboard bracket being found on a left-hand side of a motorcycle in a left footrest position, said rockerboard bracket comprising a motorcycle footrest immovably affixed to a rockerboard bracket on a ventral side of said footrest, said rockerboard bracket being a member selected from the group consisting of a rockerboard bracket braking bracket and a rockerboard bracket shifting bracket, said rockerboard bracket comprising a toe end and a heel end; a right rockerboard bracket, said rockerboard bracket being found on a right-hand side of said motorcycle in a right footrest position, said rockerboard bracket comprising a motorcycle footrest immovably affixed to a rockerboard bracket on a ventral side of said footrest, said rockerboard bracket being a member selected from the group consisting of a rockerboard bracket braking bracket and a rockerboard bracket shifting bracket, said group member being not identical to said left rockerboard bracket group member, said rockerboard bracket comprising a toe end and a heel end; a braking system functionally affixed to said rockerboard bracket braking bracket; and a shifting system functionally affixed to said rockerboard bracket shifting bracket.

### BACKGROUND OF THE INVENTION

1. Field of the Invention

This invention lies in the field of controls, specifically foot control mechanisms for motorcycle braking and shifting mechanisms.

2. Description of Related Art

Currently, the standard motorcycle has a dedicated foot pedal control for braking and another foot pedal for a gear-shifting or clutch function. Brakes and shifters are well known in the art in the form of foot pedals whereupon the motorcycle rider can slow the machine's velocity and also change gears. These foot pedals may be separate pedals, or they may be a single pedal that encompasses both functions. However, in all cases of which we are aware, the foot pedal control for braking or shift is a pedal separate from any footrest or footboard device that may be mounted on the motorcycle. The footrests or footboards of a motorcycle in the current art are immovably affixed to the motorcycle and they do not pivot; they function essentially as footrests.

Thus, there is a long-felt but unmet need in the art for a device that merges a motorcycle footrest or footboard with braking and/or shift functionality, with the option to have a modular unit that can be easily affixed to the motorcycle to change the unit for cosmetic purposes or to replace any worn or unusable parts within the braking or shifting functions.

### Definitions

The applicant in a patent application may act as his own lexicographer. Some of the terms listed herein, while they are used within their usual meanings, come from the language of the biological sciences and are not usually applied to this subject matter. Other terms are listed simply to clarify what may appear to be inconsistent usage in the application, or to identify and define the applicant's unique use of the term.
“anterior,” referring to the head (handlebar) end of the motorcycle (term used in the same sense as it is used in anatomy).
“chiral,” referring to left-right specificity of shape or orientation (term is used in the same sense as it is used in organic and biochemistry). For example, human feet are chiral; a left foot is generally substantially the mirror image of a right foot.
“distal,” referring to an end or side furthest from the anterior-posterior midline of the body, or, in this case, the motorcycle (term used in the same sense as it is used in anatomy).
“dorsal,” referring to the upper side of the motorcycle, looking down upon it (term used in the same sense as it is used in anatomy).
“posterior,” referring to the end opposite the anterior end of the motorcycle; the motorcycle's exhaust system eliminates engine waste from a pipe or tube with an opening facing the posterior end of the motorcycle (term used in the same sense as it is used in anatomy).
“proximal,” referring to the end or side closest to the anterior-posterior midline of the body, or in this case, the motorcycle (term used in the same sense as it is used in anatomy).
“rockerboard bracket,” referring to the bracket that ventrally supports the footboard for a motorcycle within the context of the present invention.
“ventral,” referring to the underside of the motorcycle, looking up from underneath it (term used in the same sense as it is used in anatomy).

### BRIEF DESCRIPTION OF THE DRAWINGS

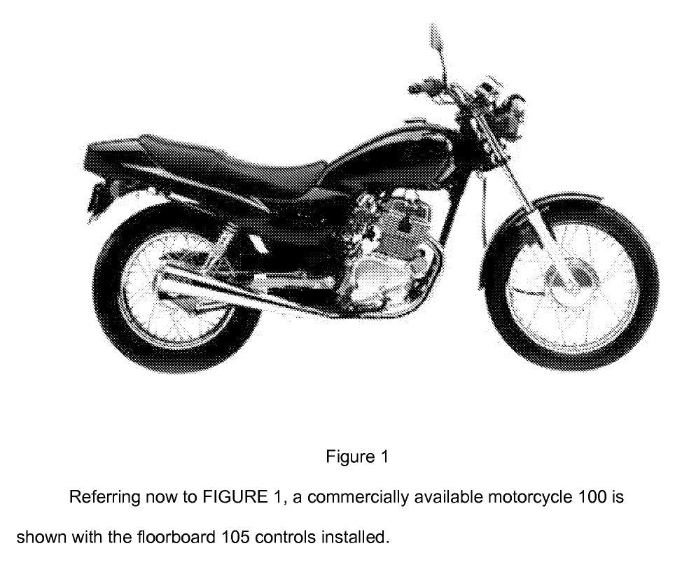

Referring now to FIG. 1, a commercially available motorcycle 100 is shown with the floorboard 105 controls installed.

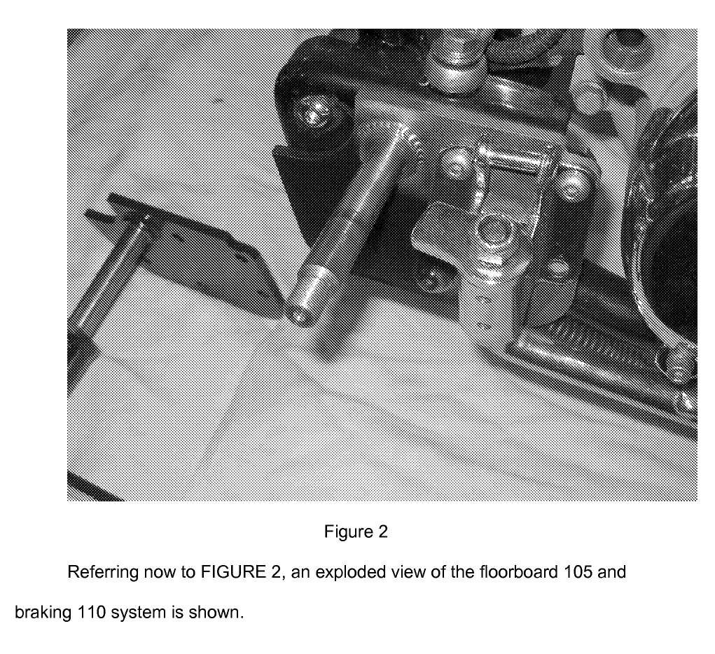

Referring now to FIG. 2, an exploded view of the floorboard 105 and braking 110 system is shown.

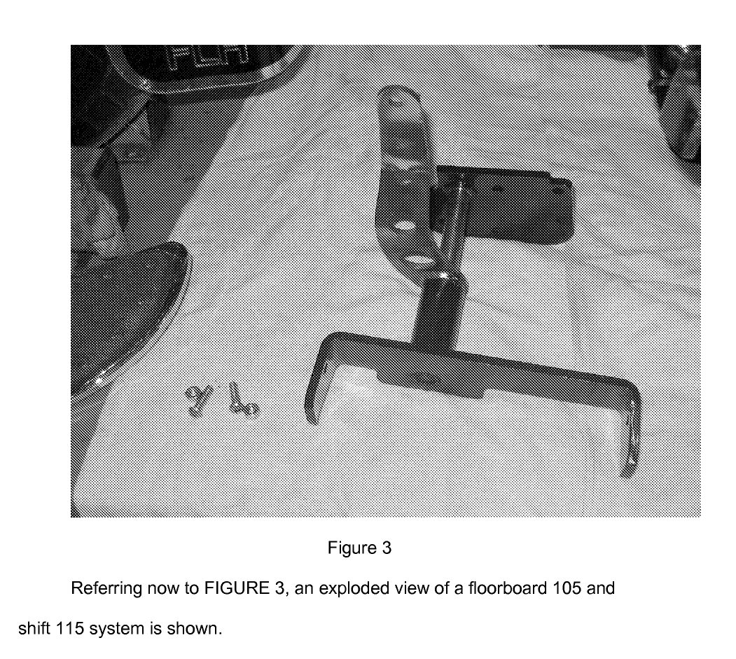

Referring now to FIG. 3, an exploded view of a floorboard 105 and shift 115 system is shown.

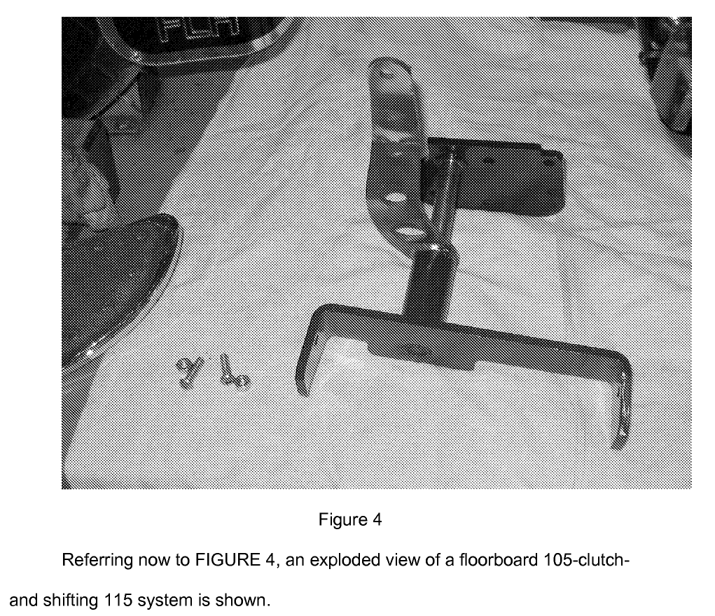

Referring now to FIG. 4, an exploded view of a floorboard 105-clutch-and shifting 115 system is shown.

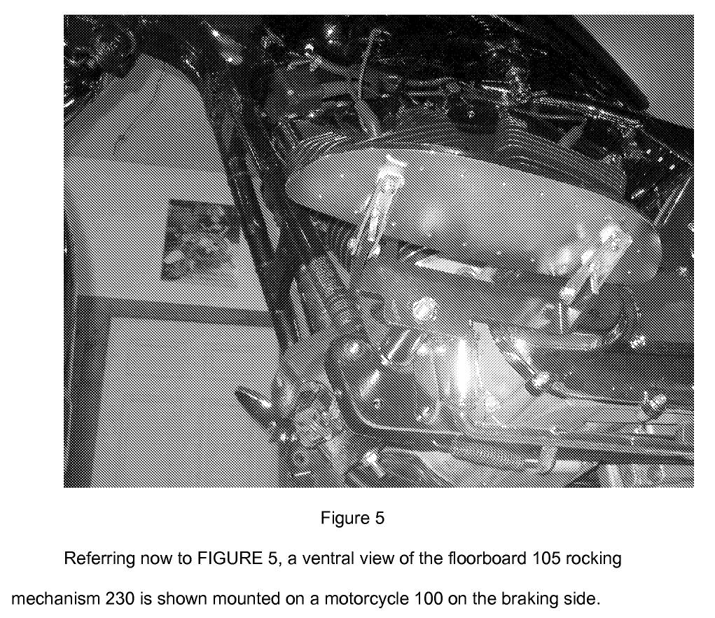

Referring now to FIG. 5, a ventral view of the floorboard 105 rocking mechanism 230 is shown mounted on a motorcycle 100 on the braking side.

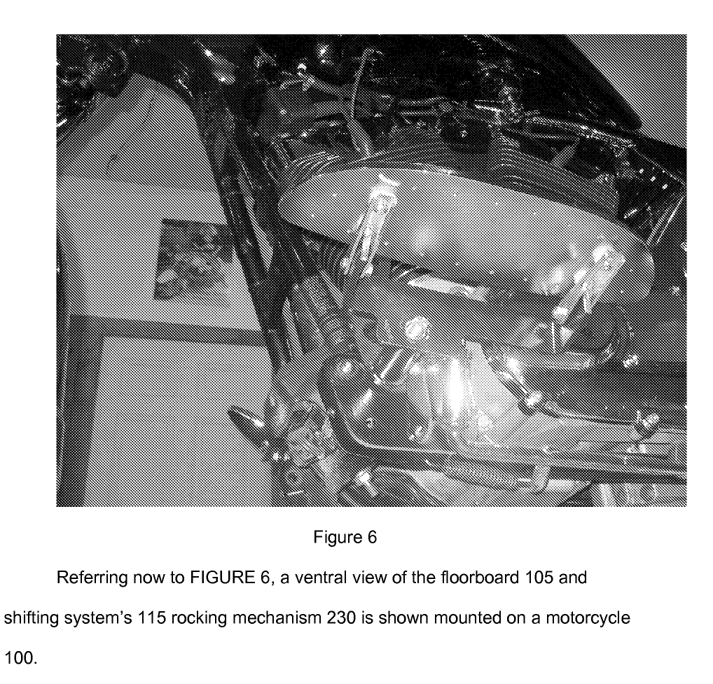

Referring now to FIG. 6, a ventral view of the floorboard 105 and shifting system's 115 rocking mechanism 230 is shown mounted on a motorcycle 100.

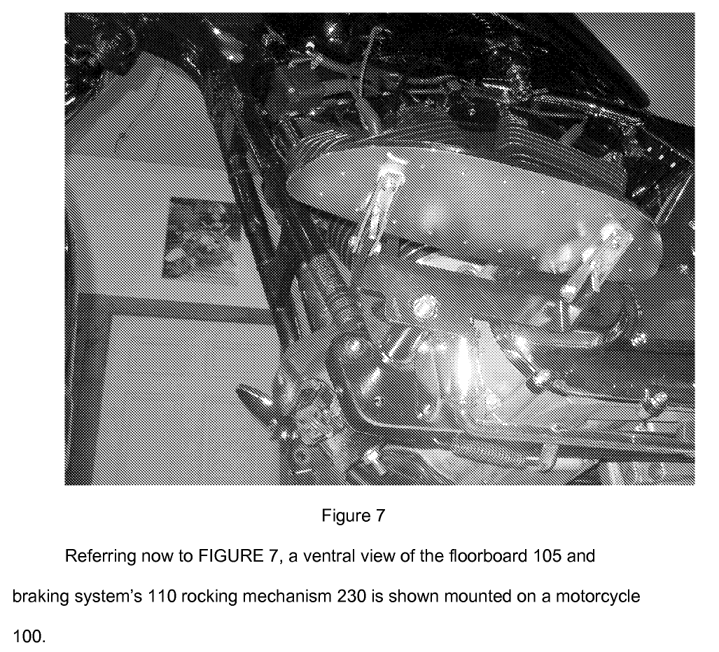

Referring now to FIG. 7, a ventral view of the floorboard 105 and braking system's 110 rocking mechanism 230 is shown mounted on a motorcycle 100.

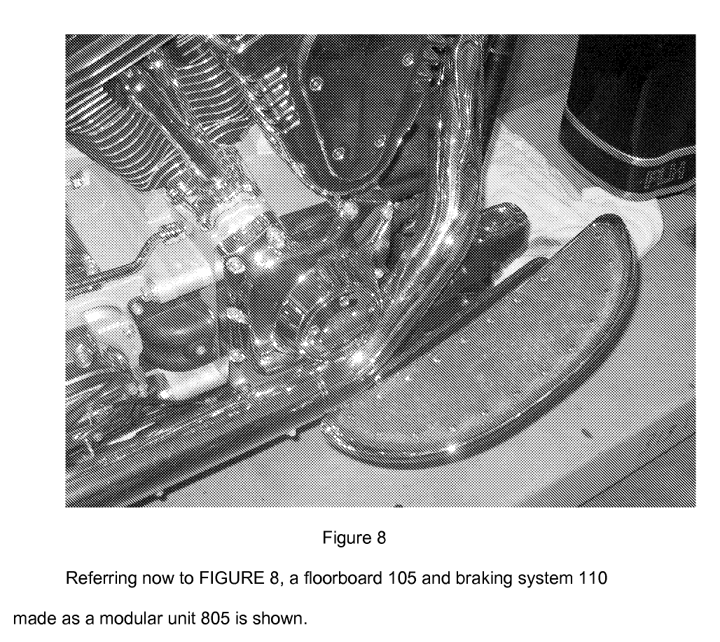

Referring now to FIG. 8, a floorboard 105 and braking system 110 made as a modular unit 805 is shown.

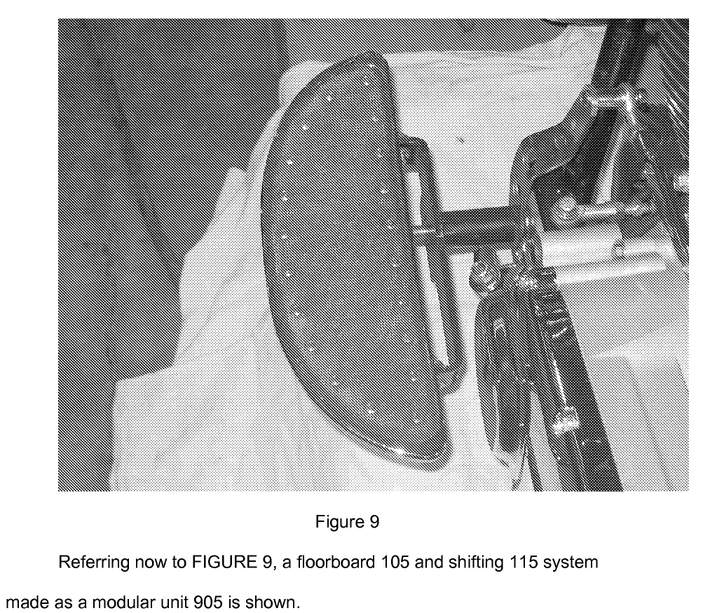

Referring now to FIG. 9, a floorboard 105 and shifting 115 system made as a modular unit 905 is shown.

### DETAILED DESCRIPTION OF THE INVENTION

Referring now to FIG. 1, a commercially available motorcycle 100 is shown with the footboard 105 braking system 110 and shifting system 115 installed.

The motorcycle's 100 standard, commercially available footboards 105, which are located on the left and right sides of the motorcycle 100 in a position where a rider can comfortably rest his feet, are removed and replaced with floorboard 105-and-braking 110 and floorboard 105-and-shifting 115 systems (hereinafter referred to as “braking system 110” and “shifting system 115”). The motorcycle 100, as shown, does not have the standard separate brake and shift foot controls; those functions are replaced by the floorboards' 105 braking 110 and shifting 115 systems in the present invention.

The floorboard 105 may be a commercially available unit, or it may be custom made. In either case, the floorboard 105 is pivotally mounted on the motorcycle. The floorboard 105 is mounted on each side of the motorcycle 100, in the position normally occupied by a footrest, and is designated as either a right floorboard 105 or a left floorboard 105, depending on to which side of the motorcycle 100, from a dorsal view, the floorboard 105 is affixed. The shape of the left and right floorboards 105 may be substantially identical to one another (rectangular or oval in a preferred embodiment; other linear, polygonal and rounded shapes are also within the scope of the invention) or they may be chiral opposites, such as substantially mirror images. Each floorboard 105 has a toe end 120 and a heel end 125. The toe end 120 is located anteriorly to the heel end 125.

The motorcycle 100 itself comprises many commercially available parts that work together in ways well known in the art, such as a gasoline tank 150, a gearbox 155 containing gears (not shown), a motor casing 160, wheels 165, fenders 170, a sissy bar 175, handlebars 180, among many others.

While the braking system 110 is generally located on the right-hand side of a motorcycle 100 and the shifting system 115 is generally located on the left-hand side, it is within the scope of the invention to reverse these systems such that the braking system 110 is on the left-hand side of the motorcycle 100 and the shifting system 115 is on the right-hand side.

Referring now to FIG. 2, an exploded view of the braking 110 system is shown.

The braking 110 system mounts on the motorcycle 100 using a commercially available brake lever pivot shaft 205 which is immovably affixed to the motorcycle 100 and pivotally supports the braking 110 system on the motorcycle. Comprising the braking system 110, a brake lever pivot 210 slides rotatingly into place and is pivotally affixed to the brake lever pivot shaft 205 by means of a commercially available blocking mechanism 215 such as a nut or pin.

The brake lever pivot 210, comprising a brake lever pivot rod 220, a brake cuff 225, and a brake lever pivot attachment 230 is immovably affixed to a braking rockerboard bracket 235 with the brake lever pivot attachment 230. The braking rockerboard bracket 235 is immovably affixed to the floorboard 105. By rotating the floorboard 105 back and forward, the brake cuff 225 is made to rotate back and forth around the brake lever pivot shaft 205.

A commercially available brake 240 is immovably affixed to the motorcycle 100. The brake compression unit 245 is attached to the brake lever pivot rod 220 by means of a brake rod 250 that is pivotally affixed to the brake lever pivot rod 220 and fixedly attached to the brake compression unit 245, which is functionally affixed to the wheel 165. When the brake is engaged by pressing on the rockerboard bracket toe end 255, the braking system 105 slows the motorcycle 100 using braking principles that are well known in the art. In another embodiment, the brake may be engaged by pressing on the rockerboard bracket heel end 260.

In the present embodiment, the brake compression unit 245 is a hydraulic master brake affixed to a hydraulic line that functionally slows the wheel. In another embodiment, the brake compression unit 245 may be a mechanical device such as a drum brake.

When the floorboard 105 is pressed, the brake lever pivot attachment 230 causes the brake cuff 225 to rotate around the brake lever pivot shaft 205. This rotation activates the brake rod 250, which compresses the brake compression unit 245. The compression unit 245 acts in the commercially available manner to slow the wheel 165.

Referring now to FIG. 3, an exploded view of the floorboard 105 and shifting system 115 is shown.

A plate 305 is installed with bolts or other permanent affixing method on the shifting side of the motorcycle 100, generally the left side but the shifting side may be the right side of the motorcycle 100 within the scope of the invention. The custom plate 305 has permanently affixed thereto a shift lever pivot shaft 310 in the present embodiment; in another embodiment, the shift lever pivot shaft 310 may be immovably affixed to the motorcycle 100 itself. The shift lever pivot shaft 310 is set to substantially a 90° angle to the anterior-posterior midline of the motorcycle 100, and substantially opposite the brake lever pivot shaft 205. A gear-shift unit 315, which comprises a shifting shaft 320 (located at the proximal side of the gear-shifting unit), a shifting cuff 325 and a shifting rockerboard bracket 330 (located at the distal side of the gear-shifting unit) where the shifting cuff is immovably affixed to both the shifting shaft 320 and the shifting rockerboard bracket 330, is pivotally affixed to the shift lever pivot shaft 310 by sliding the shifting cuff 325 around the shift lever pivot shaft 310 and affixing the shifting cuff 325 to the shift lever pivot shaft 310 with a commercially available blocking mechanism (such as a nut or pin) 350 such that the shift cuff 325 does not slide off of the shift lever pivot shaft 310.

The shifting shaft 320 has two ends. The cuff end 335 is immovably affixed to the shifting cuff 325; the rod end 340 has affixed to it a gear-shift rod or cable 345 (commercially available as a “linking rod”) which rigidly connects the shifting shaft 320 to the gearbox 155 through a shifting arm extension 355.

The shifting rockerboard bracket 330 is immovably affixed to the shifting cuff 325. The floorboard 105 is immovably affixed to the shifting rockerboard bracket 330.

When the shifting rockerboard bracket 330 is pressed with the toe or heel, the shifting rockerboard bracket 330 is pivoted by means of the shifting cuff 325 around the shift lever pivot shaft 310, moving the shifting shaft 320, thereby activating the gear-shift rod or cable 345 which shifts gears in the gearbox 155.

Referring now to FIG. 4, an exploded view of a floorboard 105 clutch and shift 115 system is shown.

A commercially available or custom-built clutch 405 is installed on the motorcycle 100, the clutch 405 being engaged and disengaged by a clutch cable or rod 410 extending from the floorboard 105 to the clutch 405. The clutch cable or rod 410 activates the clutch 405 by moving it to an engaged position when the floorboard 105 is released or to a disengaged position when the floorboard 105 is pressed. When the clutch 405 is disengaged, a hand shift lever 415 can be moved to shift the gears (not shown) on the motorcycle. When the clutch 405 is engaged, the motorcycle 100 is set in the selected gear (not shown) or, if no gear (not shown) is selected, in neutral.

The hand shift lever 415 may be commercially available or custom built. It 415 may be mounted on any part of the motorcycle 100 that the driver can easily reach, such as the gasoline tank 150 or the motor casing 160, and connected using a hand shift-lever rod or cable 420 to a gearbox 155 in such a way that moving the hand shift lever changes gears.

Referring now to FIG. 5, a ventral view of the floorboard 105 rocking mechanism 230 is shown mounted on a motorcycle 100 on the braking side.

The rocking mechanism comprises a braking rockerboard bracket 235, which supports a floorboard 105. The floorboard 105 is immovably affixed to the braking rockerboard bracket 235; the braking rockerboard bracket 235 is immovably affixed to the braking cuff 230, which is rotatingly attached to the brake lever pivot shaft 205 and to the brake rod 250. The brake rod 250 attachment is at the anterior side of the floorboard 105. As the rider presses the floorboard 105 forward with the toe end of his foot 505, the braking cuff 230 rotates forward, which causes the brake rod 250 to compress the brake compression unit 245 and slow the motorcycle with a braking system 110 that is well known in the art.

In another embodiment, the rockerboard bracket may be pressed with the heel end of the foot 510 to activate the brake. In this instance, the brake rod 250 would be located on the posterior end of the braking cuff 230 and the brake compression unit 245 may be shifted posteriorly and/or rotated 180°.

Referring now to FIG. 6, a ventral view of the shifting system's 115 rocking mechanism 230 is shown mounted on a motorcycle 100.

The shifting rockerboard bracket 330 is immovably affixed to the ventral side of the floorboard 105. The shifting rockerboard bracket 330 is also immovably affixed to the shifting cuff 325. The shifting cuff 325 is rotatingly affixed to the shift lever pivot shaft 310 and kept in place with a commercially available blocking mechanism such as a nut or pin 350. The shifting cuff 325 by its attachments 320, 330 operate the shifting system 115 as previously described. In the present embodiment, when the shifting rockerboard bracket 330 is depressed at the toe end 120, the gears are shifted up; when the shifting rockerboard bracket 330 is depressed at the heel end 125, the gears are shifted down. The reverse of this shifting mechanism is also within the scope of the invention; that is, depressing the toe end 120 of the shifting rockerboard bracket 330 can, within the scope of the invention, shift down and depressing the heel end 125 of the shifting rockerboard bracket 330 can, within the scope of the invention, shift up.

Referring now to FIG. 7, a ventral view of the braking system's 110 rocking mechanism 230 is shown mounted on a motorcycle 100.

The braking rockerboard bracket 235 is immovably affixed to the ventral side of the floorboard 105. The rockerboard bracket 235 is also immovably affixed to the braking cuff 230. The braking cuff 230 is pivotally affixed to the brake lever pivot shaft 205 and kept in place with a commercially available blocking mechanism such as a nut or pin 215. The braking cuff 230 by its attachments 225, 235, operates the braking system 110 as previously described.

Referring now to FIG. 8, a floorboard 105 and braking system 110 made as a modular unit 805 is shown.

By detaching the connectors between the proximal end of the brake lever pivot 210 and the brake 240, the floorboard 105 and the braking system 110, not including the brake 240 itself, can be detached from the motorcycle 100 for repair or replacements. The rockerboard bracket-and-braking modular unit 805 comprises an optional commercially available or custom-made floorboard 105, a braking rockerboard bracket 235, a brake lever pivot rod 220, a commercially available blocking mechanism (nut or pin) 215, a brake lever pivot 210, and a braking cuff 230. The braking cuff 230 slides onto the brake lever pivot shaft 205, and the blocking mechanism 215 is installed at the distal end of the rockerboard bracket-and-braking modular unit 805 to prevent the rockerboard bracket-and-braking modular unit 805 from sliding off the brake lever pivot shaft. The brake lever pivot rod 220 is affixed to the brake lever pivot attachment to finish affixing the unit 805 to the motorcycle 100.

In another embodiment that is within the scope of the invention, the rockerboard-and-braking modular unit 805 may also include a complete replacement for a master brake cylinder (hydraulic or mechanical) included in the unit.

Referring now to FIG. 9, a floorboard 105 and shifting 115 system made as a modular unit 905 is shown.

By detaching the connectors between the plate gear-shift rod or cable 345 and the shifting shaft, the floorboard 105 and the shifting system 115, the rockerboard bracket-and-shifting modular unit 910 is made. The rockerboard bracket-and-shifting modular unit 905 can be detached from the motorcycle 100 for repair or replacements. The rockerboard bracket-and-shifting modular unit 905 comprises an optional floorboard 105, a shifting rockerboard bracket 330, a shifting shaft 320, a shifting cuff 325 and a commercially available blocking mechanism (nut or pin) 350. The shifting cuff 325 slides onto the shift lever pivot shaft 310, and the blocking mechanism 350 is installed at the distal end of the rockerboard bracket-and-shifting modular unit 905 to prevent the rockerboard bracket-and-shifting modular unit 905 from sliding off the brake lever pivot shaft. The gear shift rod or cable 345 is affixed to the shifting shaft rod end 340 to finish affixing the unit 905 to the motorcycle 100.

In the current embodiment, the floorboard 105 and braking 110 system and the floorboard 105 and shift 115 system are each installed on separate rockerboard brackets. However, it is conceivable and within the scope of the invention that that floorboard 105 and braking 110 system may be installed on the same side as the floorboard 105 and shift 115 system. One function could, for example, be activated by rocking the floorboard 105 forward and backward (anterior-posterior), the other by rocking the floorboard 105 backward from side to side (proximal-distal).

In the current embodiment, the floorboard 105 is a solid piece that extends from anterior to posterior and allows a rider's entire foot to rest thereupon. It is also within the scope of the invention that the floorboard 105 may be replaced with one or two pegs or pedals immovably affixed to the rockerboard bracket 235, 330 at the toe end 120 and/or heel end 125.

The embodiments provided here are examples only and are not intended to be a complete listing of possible embodiments, nor should they be construed as an exclusive listing of embodiments. Variations in the described invention and its uses are possible within the scope of this disclosure without departing from the subject matter coming within the scope of the claims herein, and a reasonable equivalency thereof, which I regard as my invention.

I claim:

1. A motorcycle foot control mechanism comprising:
a left rockerboard bracket, said rockerboard bracket being found on the left-hand side of a motorcycle in a left footrest position, said rockerboard bracket comprising a motorcycle footrest immovably affixed to a rockerboard bracket on a ventral side of said footrest, said rockerboard bracket being a member selected from the group consisting of a rockerboard bracket braking bracket and a rockerboard bracket shifting bracket, said rockerboard bracket comprising a toe end and a heel end;
a right rockerboard bracket, said rockerboard bracket being found on the right-hand side of said motorcycle in a right footrest position, said rockerboard bracket comprising a motorcycle footrest immovably affixed to a rockerboard bracket on a ventral side of said footrest, said rockerboard bracket being a member selected from the group consisting of a rockerboard bracket braking bracket and a rockerboard bracket shifting bracket, said group member being not identical to said left rockerboard bracket group member, said rockerboard bracket comprising a toe end and a heel end;
a braking system functionally affixed to said rockerboard bracket braking bracket; and
a shifting system functionally affixed to said rockerboard bracket shifting bracket.

2. The motorcycle foot control mechanism of claim 1 further comprising said braking mechanism being mounted on said motorcycle using a commercially available brake lever pivot shaft which is immovably affixed to said motorcycle, said brake lever pivot shaft pivotally supporting said braking system.

3. The motorcycle foot control mechanism of claim 1 further comprising said braking system comprising a brake lever pivot pivotally affixed to said brake lever pivot shaft and held in place with a commercially available blocking mechanism.

4. The motorcycle foot control mechanism of claim 3 further comprising said commercially available blocking mechanism being a member selected from the group consisting of a nut and a pin.

5. The motorcycle foot control mechanism of claim 1 further comprising said brake lever pivot comprising a brake lever pivot rod, a brake cuff, and a brake lever pivot attachment.

6. The motorcycle foot control mechanism of claim 5 further comprising said brake lever pivot attachment being immovably affixed to said braking rockerboard bracket by said brake lever pivot attachment.

7. The motorcycle foot control mechanism of claim 1 further comprising a said braking system comprising a commercially available brake being immovably affixed to said motorcycle, a brake compression unit being attached to said brake lever pivot rod by means of a brake rod that is pivotally affixed to said brake lever pivot rod and fixedly attached to said brake compression unit, said brake being functionally affixed to a wheel.

8. The motorcycle foot control mechanism of claim 1 further comprising said shifting mechanism operating without a clutch.

9. The motorcycle foot control mechanism of claim 8 further comprising said shifting mechanism being pivotally attached to said motorcycle by a shifting cuff that is pivotally affixed to a shift lever pivot shaft, wherein said shifting cuff is immovably affixed to a shifting shaft that functions in a commercially available manner to shift gears on said motorcycle.

10. The motorcycle foot control mechanism of claim 1 further comprising said shifting mechanism operating with a clutch.

11. The motorcycle foot control mechanism of claim 10 further comprising said shifting mechanism being attached to said motorcycle by a shifting cuff that is pivotally affixed to a shift lever pivot shaft, wherein said shifting cuff is immovably affixed to a clutch that functions in a commercially available manner to engage or disengage gears in a commercially available gearbox, said gears being shifted by a hand shift lever affixed to said gearbox in a commercially available manner.

12. The motorcycle foot control mechanism of claim 1 further comprising said shifting system comprising a plate installed with bolts onto said motorcycle, said plate having permanently affixed thereto a shift lever pivot shaft.

13. The motorcycle foot control mechanism of claim 12 further comprising a gear-shift unit, said gear-shift unit comprising a shifting shaft, a shifting cuff that pivotally surrounds said shift lever pivot shaft, and said shifting rockerboard bracket, said shifting shaft being immovably affixed to a proximal end of said shifting cuff and said rockerboard bracket being immovably affixed to a distal end of said shifting cuff, said gear-shift unit being held in place upon said shift lever pivot shaft by a commercially available blocking mechanism, said commercially available blocking mechanism being a member selected from the group consisting of a nut and a pin.

14. The motorcycle foot control of claim 10 further comprising said clutch being engaged and disengaged by a clutch cable or rod extending from said shifting shaft to said clutch and activating said clutch by moving said clutch to a disengaged position when said rockerboard bracket toe end is pressed or an engaged position when said rockerboard bracket toe end is released.

15. The motorcycle foot control mechanism of claim 1 further comprising said rockerboard bracket braking mechanism being engaged by pressing said rockerboard bracket at a member selected from the group consisting of said rockerboard bracket toe end and said rockerboard bracket heel end.

16. The motorcycle foot control mechanism of claim 1 further comprising said rockerboard bracket and braking unit being a modular unit for ease of removal and replacement.

17. The motorcycle foot control mechanism of claim 1 further comprising said rockerboard bracket and braking unit being a modular unit for ease of removal and replacement.

18. The motorcycle foot control mechanism of claim 1 further comprising said floorboard 105 and shifting unit being easily removed and replaced as a modular unit.

19. A motorcycle foot control mechanism comprising:
a left rockerboard bracket, said rockerboard bracket being found on a left-hand side of a motorcycle in a left footrest position, said rockerboard bracket comprising a motorcycle footrest immovably affixed to a rockerboard bracket on a ventral side of said footrest, said rockerboard bracket being a member selected from the group consisting of a rockerboard bracket braking bracket and a rockerboard bracket shifting bracket;
a right rockerboard bracket, said rockerboard bracket being found on a right-hand side of said motorcycle in a right footrest position, said rockerboard bracket comprising a motorcycle footrest immovably affixed to a rockerboard bracket on a ventral side of said footrest, said rockerboard bracket being a member selected from the group consisting of a rockerboard bracket braking bracket and a rockerboard bracket shifting bracket, said group member being not identical to said left rockerboard bracket group member;
a braking system functionally affixed to said rockerboard bracket braking bracket wherein said braking mechanism comprises a brake lever pivot pivotally affixed to said brake lever pivot shaft and held in place with a commercially available blocking mechanism, said commercially available blocking mechanism being a member selected from the group consisting of a nut and a pin, and said braking mechanism being mounted on said motorcycle using a commercially available brake lever pivot shaft which is immovably affixed to said motorcycle, said brake lever pivot shaft pivotally supporting said braking system; and
a shifting system functionally affixed to said rockerboard bracket shifting bracket, said shifting system operating using a member selected from the group consisting of without a clutch and with a clutch, said shifting system being pivotally attached to said motorcycle by a gear-shift unit, said gear-shift unit comprising a shifting cuff, said shifting cuff being immovably affixed proximally to said shifting shaft and distally to said shifting rockerboard bracket, said shifting cuff being pivotally affixed to said shift lever pivot shaft by a commercially available blocking mechanism, said commercially available blocking mechanism being selected from the group consisting of a nut and a pin.

20. The motorcycle foot control mechanism of claim 19 further comprising said shifting shaft being pivotally affixed to a shifting rod or cable, said shifting rod or cable being affixed to a clutch that functions in a commercially available manner to engage or disengage gears in a commercially available gearbox, said gears being shifted by a hand shift lever affixed to said gearbox and to said motorcycle in a commercially available manner.

21. The motorcycle foot control mechanism of claim 19 further comprising said shifting shaft being pivotally affixed to a shifting rod or cable, said shifting rod or cable being functionally affixed to a commercially available gearbox, said gears being shifted up by pressing a rockerboard bracket toe end or down by pressing a rockerboard bracket heel end.

22. The motorcycle foot control mechanism of claim 19 further comprising said shifting shaft being pivotally affixed to a shifting rod or cable, said shifting rod or cable being functionally affixed to a commercially available gearbox, said gears being shifted up by pressing a rockerboard bracket heel end or down by pressing a rockerboard bracket toe end.

23. The motorcycle foot control mechanism of claim 19 further comprising said rockerboard bracket and braking unit being a modular unit for ease of removal and replacement.

24. The motorcycle foot control mechanism of claim 19 further comprising said rockerboard bracket and shifting unit being a modular unit for ease of removal and replacement.

25. A motorcycle foot control mechanism comprising:
a left rockerboard bracket, said rockerboard bracket being found on a left-hand side of a motorcycle in a left footrest position, said rockerboard bracket comprising a motorcycle footrest immovably affixed to a rockerboard bracket braking bracket, said rockerboard bracket braking bracket being mounted on a ventral side of said rockerboard bracket, said left rockerboard bracket and rockerboard bracket brakaing bracket being optionally modular for ease of removal and replacement, said rockerboard bracket comprising a heel end and a toe end;
a right rockerboard bracket, said rockerboard bracket being found on a right-hand side of said motorcycle in a right footrest position, said rockerboard bracket comprising a motorcycle footrest immovably affixed to a rockerboard bracket, said rockerboard bracket being mounted on a ventral side of said footrest, said rockerboard bracket being a member selected from the group consisting of a rockerboard bracket braking bracket and a rockerboard bracket shifting bracket, said group member being not identical to said left rockerboard bracket group member, said right rockerboard bracket being optionally modular for ease of removal and replacement, said rockerboard bracket comprising a heel end and a toe end;
a braking system functionally affixed to said rockerboard bracket braking bracket wherein said braking mechanism comprises a brake cuff pivotally affixed to a brake lever pivot shaft, said brake lever pivot shaft being immovably affixed to said motorcycle in a footrest position, and held in place with a commercially available blocking mechanism, said commercially available blocking mechanism being a member selected from the group consisting of a nut and a pin, said brake cuff being immovably affixed on a proximal end to a brake cable or rod and on a distal end to said rockerboard bracket braking bracket, said brake cable or rod being functionally affixed to a brake rod, said brake rod being functionally affixed to a brake compression unit within a commercially available brake, said brake being functionally affixed to a wheel upon said motorcycle, said braking mechanism being activated by pressing a toe end of said rockerboard bracket to move said brake cuff, thereby pressing against said brake compression unit and slowing said wheel; and
a shifting system functionally affixed to said rockerboard bracket shifting bracket, said shifting system operating using a member selected from the group consisting of without a clutch and with a clutch, said shifting system being pivotally attached to said motorcycle by a gear-shift unit, said gear-shift unit comprising a shifting cuff, said shifting cuff being immovably affixed proximally to a shifting shaft and distally to said shifting rockerboard bracket, said shifting cuff being pivotally affixed to said shift lever pivot shaft by a commercially available blocking mechanism, said commercially available blocking mechanism being selected from the group consisting of a nut and a pin, said shifting shaft having a cuff end and a rod end and being immovably affixed to said shifting cuff at said cuff end and hingedly affixed to a shifting rod or cable at said rod end, said shifting rod or cable being optionally affixed to a clutch or to a gearbox, said shifting rod or cable when affixed to said gearbox operating to shift gears down when said rockerboard bracket toe end is pressed and to shift gears up when said rockerboard bracket heel end is pressed, said shifting rod operating to disengage said clutch, when present, when said rockerboard bracket toe end is pressed and to engage said clutch when said rockerboard bracket heel end is pressed.
